(19) United States
(12) Patent Application Publication
(10) Pub. No.: US 2012/0165493 A1
(43) Pub. Date: Jun. 28, 2012

(54) ISOCYANATE-FREE SILANE-CROSSLINKING COMPOUNDS

(75) Inventors: Volker Stanjek, Ampfing (DE); Bernd-Josef Bachmeier, Haiming (DE); Andreas Bauer, Kirchdorf (DE)

(73) Assignee: Wacker Chemie AG, Muenchen (DE)

(21) Appl. No.: 13/394,161

(22) PCT Filed: Apr. 13, 2010
(86) PCT No.: PCT/EP2010/054811

§ 371 Date: Mar. 6, 2012

(30) Foreign Application Priority Data
Sep. 4, 2009 (DE) 10 2009 029 200.4

(51) Int. Cl. C09J 183/08; C08G 77/26

(52) U.S. Cl. 528/17; 528/38; 528/14

(57) ABSTRACT

The invention relates to compounds (K) comprising A) 100 parts by weight of a pre-polymer (P) comprising units (E) in the backbone thereof that are selected from polyether and polyester units, wherein the pre-polymer (P) comprises at least one end group of the general formula (1) -L¹-(CH₂)_{y}—SiR²₃₋ₓ(OR¹)ₓ (1), B) 1 to 100 parts by weight of silane (S) of the general formula (2) R⁴SiR²_{3-Z}(OR¹)_{z} (2), (G) 0 to 10 parts by weight of a curing catalyst (HK) that accelerates the curing of the compounds (K) in the presence of humidity, wherein L¹ represents a divalent linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³) and R¹, R², R³, x, y and z have the meanings cited in claim 1. R⁴ are hydrocarbon radicals having at least 7 hydrogen atoms. According to the invention, after hardening, the compounds (K) have high shear strength and are used as adhesives (K).

The invention relates to one-component, silane-crosslinking compositions which are used as adhesives having high tensile shear strength and high curing rate.

Among the known means of implementing adhesive bonds on wood are wood glues, formulated typically on the basis of polyvinyl acetate dispersions. Although they exhibit good adhesion to wood, their setting rate, i.e., the time which elapses before a loadable bond is formed, is very long, and so mechanical fixing of the workpieces that are to be bonded, for some time, is generally unavoidable. Furthermore, the use of this type of adhesive presents problems if the bond is exposed to moisture, since the wood glues typically have only limited resistance toward water.

In the case of wooden constructions which are subject to high stresses, where the requirements imposed on the mechanical strength of the components are exacting and the bond strength is still to be high enough even after many years under the effects of weathering, wood glues of this kind are usually not appropriate.

Here, customarily, isocyanate-crosslinking PU adhesives are used. These adhesives typically comprise aromatic polyisocyanates. Systems of this kind cure by reaction of the isocyanate groups with (atmospheric) moisture.

Since PU adhesives cure via a chemical crosslinking reaction and are able to attach chemically as well to the wood substrate, they exhibit significantly better mechanical properties and are also substantially more resistant toward external (weathering) effects such as moisture or direct water contact.

The general performance of adhesives is specified through compliance with standards, such as, for example, DIN EN 204, durability classes D1-D4. These standards can generally be met by isocyanate-crosslinking adhesives.

Nevertheless, even some isocyanate-crosslinking adhesives possess massive disadvantages inherent in the system. For example, one-component PU adhesive systems generally possess no more than moderate cure rates. It is true that the isocyanate crosslinking can in principle be accelerated sharply by aggressive catalysis. However, since such catalysis in principle also catalyzes unwanted side reactions of the isocyanate groups (e.g., formation of allophanates, uretdiones, isocyanurates, etc.), the systems in question then no longer have sufficient shelf life.

Another disadvantage of the isocyanate-crosslinking adhesives is the sensitizing effect of all the isocyanate-containing compounds. Moreover, many monomeric isocyanates are toxic or even very toxic and/or are suspected of being carcinogenic. This presents problems insofar as the end user, i.e., the craftworker or do-it-yourself user, comes into contact not only with the cured and hence isocyanate-free and entirely unobjectionable product, but also with the isocyanate-containing adhesive. For the unpracticed home improver there is a particular risk here that the products may not be used expertly and/or properly. Additional hazards arise here from incorrect storage as well, such as storage within the reach of children. With the professional craftworker, on the other hand, proper use and storage can be assumed. Here, however, the problem may exist that the professional is required regularly—possibly even a number of times a day—to work with the isocyanate-containing material, a fact which is potentially critical in view in particular of the aforementioned sensitizing effect of isocyanates.

Somewhat more favorable here are isocyanate-crosslinking adhesives which contain only very low levels of volatile isocyanates and are therefore at least free from labeling requirements. These adhesives, however, are mostly based on aliphatic isocyanates, which in turn are less reactive. For applications where rapid setting of the adhesive is a factor, therefore, these adhesives are once again less favorable than conventional PU adhesives.

An alternative curing technology which is finding application increasingly in the adhesives sector is that of silane crosslinking, where alkoxy silane-functional prepolymers on contact with atmospheric moisture, initially undergo hydrolysis and then cure through a condensation reaction. The corresponding silane-functional—usually silane-terminated—prepolymers are entirely unobjectionable from the standpoint of toxicology.

While conventional silane-crosslinking systems have long had the disadvantage of a relatively low cure rate, more recent times have seen descriptions also of highly reactive systems, such as in EP 1414909 or in EP 1421129.

Customary silane-crosslinking adhesives consist in their backbone of long-chain polyethers, having molar masses which are usually of the order of 10 000 daltons or more. Occasionally somewhat shorter-chain polyethers—typically with molar masses of 4000-8000 daltons, are used as well, and are then linked with diisocyanates to form longer units. Here as well, therefore, overall, very high molecular mass prepolymers are obtained, whose backbone continues to consist substantially of long-chain polyether units, the polyether chain being interrupted by a small number of urethane units. Systems of this kind are described in WO 05/000931, for example.

A disadvantage of all of these common silane-crosslinking systems, however, is a relatively low tensile shear strength. Consequently, customary applications for this new type of adhesive are generally confined to sectors in which the requirement is for elastic adhesives more than for adhesives of high tensile strength. Adhesives which meet European standard DIN EN 204, durability class D4, have not hitherto been achievable with silane-crosslinking adhesives.

The invention provides compositions (K) comprising
A) 100 parts by weight of a prepolymer (P) comprising in its backbone units (E) selected from polyether units and polyester units, the prepolymer (P) having at least one end group of the general formula (1)

-L¹-(CH₂)_{y}—SiR²₃₋ₓ(OR¹)ₓ (1),
B) 1 to 100 parts by weight of silane (S) of the general formula (2)

R⁴SiR²_{3-z}(OR¹)_{z} (2),
C) 0 to 10 parts by weight of a curing catalyst (HK) which accelerates the curing of the compositions (K) in the presence of atmospheric moisture, where
   L¹ is a divalent linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³),
   R¹ and R² are unsubstituted or halogen-substituted hydrocarbon radicals having 1-6 carbon atoms, or hydrocarbon radicals interrupted by nonadjacent oxygen atoms and having a total of 2-20 carbon atoms,
   R³ is hydrogen, an unsubstituted or halogen-substituted cyclic, linear or branched C₁ to C₁₈ alkyl or alkenyl radical, a C₆ to C₁₈ aryl radical or a radical of the formula —(CH₂)_{y}—SiR²₃₋ₓ(OR¹)x,
   R⁴ is an unsubstituted or halogen-substituted linear, branched or cyclic alkyl, alkenyl or arylalkyl radical having at least 7 carbon atoms,
   y is a number from 1 to 10,
   x is the value 2 or 3, and
   z is the value 1, 2 or 3.

The prepolymers (P) are preferably characterized in that they have been prepared from polyols (P1) selected from polyether polyols, polyester polyols or mixtures of different polyether and/or polyester polyols, the polyols (P1) or polyol mixtures (P1) having an average molar mass of not more than 2000 daltons.

With particular preference the prepolymers (P) having end groups of the general formula (1) in their backbone have not only the polyether and/or polyester units (E) but also additional urethane units.

Furthermore, the prepolymers (P) are preferably characterized in that as well as the silane termini of the general formula (1) they also possess termini of the general formula (3)

L²-R⁵ (3),

where
R⁵ is an unsubstituted or halogen-substituted linear, branched or cyclic alkyl, alkenyl or arylalkyl radical having at least 7 carbon atoms, and
L² has the same definition as L¹.

Preferably at least 2%, more preferably at least 4%, and preferably not more than 40%, more particularly not more than 20%, of all of the chain ends of the prepolymers (P) are terminated with groups of the general formula (3).

The invention is based on four discoveries. Thus it was first observed that the addition of alkylsilanes (S) having long-chain alkyl groups leads to an improvement in the mechanical properties of the resultant cured compositions (K). More particularly this addition gives the otherwise relatively brittle materials, surprisingly, the elasticity that is necessary for a high tensile shear strength. Also surprising is the fact that the addition of the silanes (S) massively improves the hot water resistance required for wood adhesives by the DIN EN 204 D4 standard among others. Moreover, the addition of alkylsilanes (S) also significantly improves the processing properties of the compositions (K), through a reduction in viscosity.

Likewise surprising was the second discovery, whereby compositions (K) with prepolymers (P) based on short-chain polyols (P1) and/or polyol mixtures (P1) having average molar masses of not more than 2000 daltons cure to give significantly harder and more tensile shear-resistant materials than compositions with prepolymers based on long-chain polyols, of the kind used typically for conventional silane-crosslinking adhesives and sealants.

Thirdly it was discovered that prepolymers (P) which as well as the silyltermini of the general formula (1) also possess chain termini of the general formula (3) surprisingly show a significantly better compatibility with the silanes (S). The processing properties of the materials in question are significantly improved as a result.

The last surprising discovery was the fact that with prepolymers (P) which as well as the silyltermini of the general formula (1) also possess chain termini of the general formula (3) it is possible to obtain compositions (K) which after they have cured are significantly more resistant to hot water than cured compositions (K) which do not possess any chain ends of the general formula (3).

In the formulae given above, L¹ is preferably a divalent linking group selected from —O—CO—NH— or —NH—CO—N(R³)—, the latter being particularly preferred.

L² is preferably a divalent linking group selected from —NH—CO—N(R³)—, —N(R³)—CO—NH—, —O—CO—NH—, and —NH—CO—O, the last-mentioned group being particularly preferred.

The radicals R¹ and R² are preferably hydrocarbon radicals having 1 to 6 carbon atoms, more particularly an alkyl radical having 1 to 4 carbon atoms, such as methyl or ethyl or propyl radicals. R² is more preferably a methyl radical; R¹ more preferably represents methyl or ethyl radicals.

The radical R³ is preferably hydrogen or a hydrocarbon radical having 1 to 10 carbon atoms, more preferably hydrogen, a branched or unbranched alkyl radical having 1 to 6 carbon atoms, such as methyl or ethyl or propyl radicals, a cyclohexyl radical or a phenyl radical.

y is preferably 1 or 3, more preferably 1. The last-mentioned value is particularly preferred on account of the fact that the corresponding prepolymers (P), in which the silyl group is separated only by one methylene spacer from an adjacent heteroatom, are notable for particularly high reactivity toward atmospheric moisture. The resulting compositions (K) have correspondingly short setting times and, furthermore, generally no longer require any heavy metal-containing catalysts, and more particularly no tin-containing catalysts.

The radical R⁴ is preferably a linear or branched alkyl or alkenyl radical having at least 8 carbon atoms, with alkyl radicals having at least 8 carbon atoms, more particularly alkyl radicals having at least 12 carbon atoms, being particularly preferred. Preferably R⁴ has not more than 40, more preferably not more than 25, carbon atoms.

The variable z is preferably 2 or 3, more preferably 3.

The radical R⁵ is preferably a linear or branched alkyl or alkenyl radical having at least 8 carbon atoms, with linear alkyl radicals having at least 8 carbon atoms, more particularly alkyl radicals having at least 10 carbon atoms, being particularly preferred. Preferably R⁵ has not more than 30, more preferably not more than 20, carbon atoms.

In the preparation of the prepolymers (P) it is preferred to start from polyether polyols and/or polyester polyols (P1) having an average molar mass of not more than 2000, more particularly not more than 1500, daltons, with polyether polyols being particularly preferred. Especially preferred are polyether polyols having an average molar mass of not more than 1000 daltons. The preferred polyether types are polyethylene glycols and more particularly polypropylene glycols. The polyols (P1) may be branched or unbranched. Particular preference is given to unbranched polyols or else to polyols having one branching site. It is also possible to use mixtures of branched and unbranched polyols.

In the preparation of the prepolymers (P), the polyols (P1) are preferably reacted with at least one isocyanate-functional compound. The prepolymers (P) are prepared optionally in the presence of a catalyst. Suitable catalysts are, for example, the bismuth-containing catalysts, such as, for example, the Borchi® Kat 22, Borchi® Kat VP 0243, Borchi® Kat VP 0244 from Borchers GmbH or else those compounds which are added to the composition (K) as curing catalysts (HK).

The prepolymers (P) are synthesized preferably at temperatures of at least 0° C., more preferably at least 60° C., and preferably not more than 150° C., more particularly not more than 120° C. This synthesis may take place continuously or discontinuously.

In one preferred mode of preparing the prepolymers (P), the aforementioned polyols or polyol mixtures (P1) are used with a silane (P2) which is selected from silanes of the general formulae (4)

OCN—(CH₂)_{y}—SiR²₃₋ₓ(OR¹)ₓ (4),

where R¹, R², x and y have the definitions indicated for the general formula (1).

Furthermore, as a third prepolymer component, it is also possible to use a di- or polyisocyanate (P3) as well. Examples of commonplace diisocyanates are diisocyanatodiphenylmethane (MDI), both in the form of crude or technical MDI and in the form of pure 4,4′ or 2,4′ isomers or mixtures thereof, tolylenediisocyanate (TDI) in the form of its different regioisomers, diisocyanatonaphthalene (NDI), isophorone diisocyanate (IPDI) or else hexamethylene diisocyanate (HDI). Examples of polyisocyanates are polymeric MDI (P-MDI), triphenylmethane triisocyanate or else trimers (biurets or isocyanurates) of the aforementioned diisocyanates.

Finally, as a fourth prepolymer component, it is also possible to use monomeric alcohols (P4) as well. These alcohols may possess one or else two or more hydroxyl groups. With regard to the molar mass and the degree of branching of the alcohols (P4) there are no restrictions at all.

As alcohols (P4) it is preferred to use compounds of the general formula (5)

R⁵OH (5)

where R⁵ has the definition indicated for the general formula (3). In the synthesis of the prepolymers (P), these alcohols, through a reaction with the di- or polyisocyanates (P3), form chain termini of the general formula (3).

All of the prepolymer components are preferably used in a proportion whereby there is preferably at least 0.6, more preferably at least 0.8, and preferably not more than 1.4, more particularly not more than 1.2, isocyanate-reactive groups per isocyanate group.

The reaction product is preferably isocyanate-free. The sequence in which the components (P1) to (P4) are reacted with one another here is arbitrary.

In one particularly preferred preparation process for the prepolymers (P), the aforementioned polyols or polyol mixtures (P1) are used with a di- or polyisocyanate (P3′). Here it is possible to use the same isocyanate-functional compounds already described above as isocyanates (P3). The isocyanates (P3′) here are used in excess, thus giving an isocyanate-terminated “intermediate prepolymer” (ZW).

This “intermediate prepolymer” (ZW) is then reacted, in a second reaction step, with an isocyanate-reactive silane (P2′) selected from silanes of the general formulae (6)

B—(CH₂)_{y}—SiR²₃₋ₓ(OR¹)ₓ (6),

where B is isocyanate-reactive group, preferably a hydroxyl group or more preferably an amino group of the formula NHR³, and x, y, R¹, R² and R³ have the definitions indicated above.

The sequence of the synthesis steps can in principle also be switched. Accordingly, the first synthesis step may in principle also be a reaction of the isocyanate (P3′) with the silane (P2′), and the reaction with the polyol (P1) may only take place in the second reaction step. It is also conceivable for both reaction steps to be carried out simultaneously. These reactions as well may be carried out either discontinuously or continuously.

Finally here monomeric alcohols (P4′) as well may be incorporated, as a fourth prepolymer component, into the polymer (P). The alcohols (P4′) may possess one or else two or more hydroxyl groups. With regard to the molecular mass and the degree of branching of the alcohols (P4′) there are no restrictions at all.

As alcohols (P4′) it is preferred to use compounds of the abovementioned general formula (5). This results in prepolymers (P) whose chain ends are not exclusively silane-terminated, but instead also possess a certain fraction, preferably at least 2%, more preferably at least 4%, and preferably not more than 40%, more particularly not more than 20%, of chain ends of the general formula (3).

The alcohols (P4′) here may be incorporated in a separate reaction step into the prepolymers (P), as for example before or after the reaction of the polyols (P1) with the isocyanates (P3′). Alternatively, however, the incorporation may also take place simultaneously with another reaction step, as for example by reacting a mixture of the polyols (P1) and the alcohols (P4′) with the isocyanates (P3′).

It is preferred here to use alcohols (P4′), mixtures of different alcohols (P4′) or else mixtures of polyols (P1) and alcohols (P4′) which are liquid at room temperature and, accordingly, can be easily metered in to the reaction mixture.

In the case of this second preferred preparation process for the prepolymers (P), as well, all of the prepolymer components are used in a proportion whereby there is preferably at least 0.6, more preferably at least 0.8, and preferably not more than 1.4, more particularly not more than 1.2, isocyanate-reactive groups per isocyanate group. The reaction product is preferably isocyanate-free.

Examples of silanes (S) are n-octyltrimethoxysilane, isooctyltrimethoxysilane, n-octyltriethoxysilane, isooctyltriethoxysilane, the various stereoisomers of nonyltrimethoxysilane, decyltrimethoxysilane, undecyltrimethoxysilane, dodecyltrimethoxysilane, tridecyltrimethoxysilane, tetradecyltrimethoxysilane, pentadecyltrimethoxysilane, hexadecyltridecyltrimethoxysilane, heptadecyltrimethoxysilane, octadecyltrimethoxysilane, nonadecyltrimethoxysilane, and also the corresponding triethoxysilanes. Particular preference is given to n-hexadecyltrimethoxysilane.

In the formulation of the composition (K) use is made preferably of at least 5, more preferably at least 10, and preferably not more than 50, more particularly not more than 40, parts of silane (S) per 100 parts of prepolymer (P). In one particularly preferred preparation process for the compositions (K), the silanes (S) and also any further adhesive components with diluent effect but without isocyanate reactivity are already present during some or possibly even all of the synthesis steps of the prepolymers (P). Hence the prepolymer (P) is obtained directly in the form of a mixture with a very low viscosity.

The compositions (K) preferably also comprise curing catalysts (HK). Furthermore, they may comprise—other than the silanes (S)—water scavengers and silane crosslinkers (WS), fillers (F), plasticizers (W), adhesion promoters (H), rheological assistants (R), and stabilizers (S), and possibly also color pigments as well, and also other customary auxiliaries and additives.

Serving as curing catalysts (HK) here there may be, for example, titanate esters, such as tetrabutyl titanate, tetrapropyl titanate, tetraisopropyl titanate, tetraacetylacetonate titanate; tin compounds, such as dibutyl tin dilaurate, dibutyl tin maleate, dibutyl tin diacetate, dibutyl tin dioctanoate, dibutyl tin acetylacetonate, dibutyl tin oxide, or corresponding compounds of dioctyl tin, basic catalysts, e.g., aminosilanes such as aminopropyltrimethoxysilane, aminopropyltriethoxysilane, aminopropyl-methyldimethoxysilane, aminopropyl-methyldiethoxysilane, N-(2-aminoethyl)aminopropyltrimethoxysilane, N-(2-aminoethyl)aminopropyltrimethoxysilane, N-(2-aminoethyl)aminopropyltriethoxysilane, N-(2-aminoethyl)aminopropyl-methyldimethoxysilane, N-cyclohexylaminomethyltriethoxysilane, N-cyclohexylaminomethyl-methyldiethoxysilane, N-cyclohexylaminomethyl-trimethoxysilane, N-cyclohexylaminomethyl-methyldimethoxysilane, and other organic amines, such as triethylamine, tributylamine, 1,4-diazabicyclo[2.2.2]octane, N,N-bis-(N,N-dimethyl-2-aminoethyl)methylamine, N,N-dimethylcyclohexylamine, N,N-dimethylphenylamine, N-ethylmorpholinine, or acid catalysts, such as phosphoric acid or phosphoric esters, toluenesulfonic acids, and mineral acids, with preference being given to catalysts free from heavy metals.

Per 100 parts of prepolymer (P) it is preferred to use at least 0.01 part, more preferably at least 0.05 part, and preferably not more than 10 parts, more particularly not more than 1 part, of curing catalysts (HK). The various catalysts may be used both in pure form and as mixtures.

Another particularly preferred type of additive for the composition (K) is represented by alcohols (A) of the general formula (7)

R⁶OH (7)

where
R⁶ is an unsubstituted or halogen-substituted hydrocarbon radicals having 1-20 carbon atoms, or hydrocarbon radicals interrupted by nonadjacent oxygen atoms and having a total of 2-20 carbon atoms.

The radical R⁶ is preferably an alkyl radical having 1-8 carbon atoms and more preferably methyl, ethyl, isopropyl, propyl, butyl, isobutyl, tert-butyl, pentyl, cyclopentyl, isopentyl, tert-butyl, hexyl or cyclohexyl radicals. Particularly suitable alcohols (A) are ethanol and methanol.

Thus it has been found that the addition of alcohols (A) to the compositions (K) massively lowers their viscosity even when only very small amounts are added. The viscosity decrease in this case is significantly greater than is the case with additions of other low molecular mass compounds and/or solvents. Moreover, the addition of the alcohols (A) leads to a surprising improvement in the adhesive strength as determinable in accordance with European standard DIN EN 204, durability group D4. This is true more particularly of the adhesive strength after water storage.

In the formulation of the composition (K), not more than 30 parts, preferably not more than 15 parts, and more preferably not more than 5 parts of alcohol (A) are used per 100 parts of prepolymer (P). Where alcohols (A) are used, it is preferred to use at least 0.5 part and more preferably at least 1 part of alcohol (A) per 100 parts of prepolymer (P).

Serving as water scavengers and silane crosslinkers (WS) there may be, for example, vinylsilanes such as vinyltrimethoxy-, vinyltriethoxy-, vinylmethyldimethoxy-, glycidyloxypropyltrimethoxysilane, glycidyloxypropyltriethoxysilane, O-methyl-carbamatomethyl-methyldimethoxysilane, O-methyl-carbamatomethyl-trimethoxysilane, O-ethyl-carbamatomethyl-methyldiethoxysilane, O-ethyl-carbamatomethyl-triethoxysilane, alkylalkoxysilanes in general, or else other organofunctional silanes. It is of course possible here also to make use of the same aminosilanes already described in connection with the condensation catalysts (KK). These silanes then often assume a dual function, as catalyst and crosslinker silane. All silane crosslinkers (S)—more particularly all silanes having amino or glycidyloxy functions—may also function, furthermore, as adhesion promoters.

With particular preference use is made as N-cyclohexylaminoalkylsilanes such as 3-(N-cyclohexylamino)propyltrimethoxysilane, 3-(N-cyclohexylamino)propyltriethoxysilane or—more preferably—N-cyclohexylaminomethyltrimethoxysilane, N-cyclohexylaminomethyltriethoxysilane, N-cyclohexylaminomethylmethyldimethoxysilane, N-cyclohexylaminomethylmethyldiethoxysilane. These silanes exhibit a surprisingly large viscosity-reducing effect on the resulting compositions (K).

Per 100 parts of prepolymer (P) it is preferred to use 0 to 20 parts, more preferably 0 to 4 parts, of water scavengers and silane crosslinkers (WS).

Serving as fillers (F) there may be, for example, calcium carbonates in the form of natural ground chalks, ground and coated chalks, precipitated chalks, precipitated and coated chalks, clay minerals, bentonites, kaolins, talc, titanium dioxides, aluminum oxides, aluminum trihydrate, magnesium oxide, magnesium hydroxide, carbon blacks, precipitated or fumed, hydrophilic or hydrophobic silicas. Preference is given to use of calcium carbonates and precipitated or fumed, hydrophilic or hydrophobic silicas, more preferably fumed, hydrophilic or hydrophobic silicas, more particularly fumed hydrophilic silicas, as filler (F).

Per 100 parts of prepolymer (P) it is preferred to use 0 to 200 parts, more preferably 0 to 100 parts, of fillers (F).

Serving as plasticizers (W) there may be, for example, phthalate esters, such as dioctyl phthalate, diisooctyl phthalate, diundecyl phthalate, adipic esters, such as dioctyl adipate, benzoic esters, glycol esters, phosphoric esters, sulfonic esters, polyesters, polyethers, polystyrenes, polybutadienes, polyisobutenes, paraffinic hydrocarbons, and higher, branched hydrocarbons.

Per 100 parts of prepolymer (P) it is preferred to use 0 to 100 parts, more preferably 0 to 50 parts, of plasticizers (W).

Examples of adhesion promoters (H) are silanes and organopolysiloxanes having functional groups, such as, for example, those having glycidyloxypropyl, aminopropyl, aminoethylaminopropyl, ureidopropyl or methacryloyloxypropyl radicals. If, however, another component, such as the curing catalyst (HK) or the water scavenger and silane crosslinker (WS), for instance, already contains the stated functional groups, it is also possible not to add adhesion promoter (H).

As rheological additives (R) it is possible, for example, to use thixotropic agents. Mention may be made here, by way of example, of hydrophilic fumed silicas, coated fumed silicas, precipitated silicas, polyamide waxes, hydrogenated castor oils, stearate salts or precipitated chalks. The abovementioned fillers may also be utilized for adjusting the flow properties.

Per 100 parts of prepolymer (P) it is preferred to use 0 to 10 parts, more preferably 0 to 5 parts, of thixotropic agents.

As stabilizers (S) it is possible, for example, to use antioxidants or light stabilizers, such as those known as HALS stabilizers, sterically hindered phenols, thioethers or benzotriazole derivatives.

Moreover, the composition (K) may also comprise other additives as well, examples being solvents, fungicides, biocides, flame retardants and pigments.

After curing, the compositions (K) have a very high tensile shear strength. They are used preferably as adhesives (K) and preferably for adhesive bonds which after curing have a tensile shear strength of at least 7 mPa, preferably at least 8 mPa, and more preferably at least 10 mPa. They are used preferably for the bonding of wood, i.e., for adhesive bonds where at least one of the substrates to be bonded—preferably both substrates to be bonded—are made of wood. The adhesives (K) here are suitable for bonding any types of wood. They are used with particular preference for adhesive bonds which after curing meet the DIN EN 204 D1, D2, D3 and/or D4 standards.

All of the above symbols in the above formulae have their definitions in each case independently of one another. In all formulae the silicon atom is tetravalent.

In the examples which follow, all amount figures and percent figures, unless otherwise indicated, are given by weight, all pressures are 0.10 MPa (abs.), and all temperatures are 20° C.

### EXAMPLES

### Example 1

### Prepolymer without Hexadecyltrimethoxysilane

In a 500 ml reaction vessel with stirring, cooling, and heating facilities, 109.8 g (630.5 mmol) of toluene 2,4-diisocyanate (TDI) are introduced and heated to 60° C. Then a mixture of 20.7 g (85.4) mmol of hexadecyl alcohol and 124.8 g (293.6 mmol) of a polypropylene glycol having an average molar mass of 425 g/mol is added. The temperature of the reaction mixture here ought not to rise above 80° C. This is followed by stirring at 60° C. for 60 minutes.

The reaction mixture is subsequently cooled to about 50° C. and 7.5 ml of vinyltrimethoxysilane are added. Thereafter 0.42 g of Jeffcat® DMDLS from Huntsman and 120.0 g (567.8 mmol) of N-phenylaminomethyl-methyldimethoxysilane (GENIOSIL® XL 972 from Wacker Chemie AG) are added, during which the temperature ought not to rise above 80° C. This is followed by stirring at 60° C. for a further 60 minutes. In the resulting prepolymer mixture, isocyanate groups are no longer detectable by IR spectroscopy. A clear, translucent prepolymer mixture is obtained which at 50 C has a viscosity of 13.5 Pas. It is very amenable to further processing.

### Example 2

### Prepolymer with Hexadecyltrimethoxysilane

In a 500 ml reaction vessel with stirring, cooling, and heating facilities, 109.8 g (630.5 mmol) of toluene 2,4-diisocyanate (TDI) and 47.0 g of hexadecyltrimethoxysilane are introduced and heated to 60° C. Then a mixture of 20.7 g (85.4) mmol of hexadecyl alcohol and 124.8 g (293.6 mmol) of a polypropylene glycol having an average molar mass of 425 g/mol is added. The temperature of the reaction mixture here ought not to rise above 80° C. This is followed by stirring at 60° C. for 60 minutes.

The reaction mixture is subsequently cooled to about 50° C. and 0.42 g of Jeffcat® DMDLS from Huntsman and 120.0 g (567.8 mmol) of N-phenylaminomethylmethyldimethoxysilane (GENIOSIL® XL 972 from Wacker Chemie AG) are added, during which the temperature ought not to rise above 80° C. This is followed by stirring at 60° C. for a further 60 minutes. In the resulting prepolymer mixture, isocyanate groups are no longer detectable by IR spectroscopy. A clear, translucent prepolymer mixture is obtained which at room temperature has a viscosity of 10 Pas. It is very amenable to further processing.

### Example 3

### Prepolymer with Hexadecyltrimethoxysilane and Vinyltrimethoxysilane

In a 500 ml reaction vessel with stirring, cooling, and heating facilities, 109.8 g (630.5 mmol) of toluene 2,4-diisocyanate (TDI) and 47.0 g of hexadecyltrimethoxysilane are introduced and heated to 60° C. Then a mixture of 20.7 g (85.4) mmol of hexadecyl alcohol and 124.8 g (293.6 mmol) of a polypropylene glycol having an average molar mass of 425 g/mol is added. The temperature of the reaction mixture here ought not to rise above 80° C. This is followed by stirring at 60° C. for 60 minutes.

The reaction mixture is subsequently cooled to about 50° C. and 7.5 ml of vinyltrimethoxysilane are added. Thereafter 0.42 g of Jeffcat® DMDLS from Huntsman and 120.0 g (567.8 mmol) of N-phenylaminomethylmethyldimethoxysilane (GENIOSIL® XL 972 from Wacker Chemie AG) are added, during which the temperature ought not to rise above 80° C. This is followed by stirring at 60° C. for a further 60 minutes. In the resulting prepolymer mixture, isocyanate groups are no longer detectable by IR spectroscopy. A clear, translucent prepolymer mixture is obtained which at room temperature has a viscosity of 9 Pas. It is very amenable to further processing.

### Example 4

### Prepolymer with Hexadecyltrimethoxysilane and Vinyltrimethoxysilane

In a 500 ml reaction vessel with stirring, cooling, and heating facilities, 109.8 g (630.5 mmol) of toluene 2,4-diisocyanate (TDI) and 47.0 g of hexadecyltrimethoxysilane are introduced and heated to 60° C. Then a mixture of 20.7 g (85.4) mmol of hexadecyl alcohol and 124.8 g (293.6 mmol) of a polypropylene glycol having an average molar mass of 425 g/mol is added. The temperature of the reaction mixture here ought not to rise above 80° C. This is followed by stirring at 60° C. for 60 minutes.

The reaction mixture is subsequently cooled to about 50° C. and 7.5 ml of vinyltrimethoxysilane are added. Thereafter 0.42 g of Jeffcat® DMDLS from Huntsman and 145.0 g (567.8 mmol) of 3-(N-phenylamino)propyltrimethoxysilane are added, during which the temperature ought not to rise above 80° C. This is followed by stirring at 60° C. for a further 60 minutes. In the resulting prepolymer mixture, isocyanate groups are no longer detectable by IR spectroscopy. A clear, translucent prepolymer mixture is obtained which at room temperature has a viscosity of 15 Pas. It is very amenable to further processing.

### Example 5

### Preparation of a One-Component Adhesive Formulation from Abovementioned Prepolymers

88.9 g of prepolymer from example 1, 10.0 g of hexadecyltrimethoxysilane and 1.1 g of 3-aminopropyltrimethoxysilane (GENIOSIL® GF 96 from Wacker Chemie AG) are stirred together in a suitable mixing apparatus. This gives a yellowish adhesive having a viscosity of 80 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 10.6 |
| D2 (storage sequence 2) | 8.9 |
| D3 (storage sequence 3) | 3.0 |
| D3 (storage sequence 4) | 8.6 |
| D4 (storage sequence 5) | 3.1 |

### Example 6

### Preparation of a One-Component Adhesive Formulation from Abovementioned Prepolymers

86.5 g of prepolymer from example 1, 10.0 g of hexadecyltrimethoxysilane, 1.25 g of 3-glycidyloxypropyltrimethoxysilane (GENIOSIL® GF 80 from Wacker Chemie AG) and 2.25 g of 3-aminopropyltrimethoxysilane (GENIOSIL® GF 96 from Wacker Chemie) are stirred together in a suitable mixing apparatus. This gives a yellowish adhesive having a viscosity of 75 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 15.3 |
| D2 (storage sequence 2) | 9.0 |
| D3 (storage sequence 3) | 3.3 |
| D3 (storage sequence 4) | 9.1 |
| D4 (storage sequence 5) | 4.7 |

### Example 7

### Preparation of a One-Component Adhesive Formulation from Abovementioned Prepolymers

86.25 g of prepolymer from example 1, 10.0 g of hexadecyltrimethoxysilane, 2.5 g of isooctyltrimethoxysilane (Silan IO-Trimethoxy from Wacker Chemie AG) and 2.25 g of 3-aminopropyltrimethoxysilane (GENIOSIL® GF 96 from Wacker Chemie AG) are stirred together in a suitable mixing apparatus. This gives a yellowish adhesive having a viscosity of 78 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 14.0 |
| D2 (storage sequence 2) | 8.5 |
| D3 (storage sequence 3) | 3.2 |
| D3 (storage sequence 4) | 8.8 |
| D4 (storage sequence 5) | 4.6 |

### Example 8

### Preparation of a One-Component Adhesive Formulation from Abovementioned Prepolymers

98.9 g of prepolymer from example 2 and 1.1 g of 3-aminopropyltrimethoxysilane (GENIOSIL® GF 96 from Wacker Chemie AG) are stirred together in a suitable mixing apparatus. This gives a yellowish adhesive having a viscosity of 81 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 11.0 |
| D2 (storage sequence 2) | 8.7 |
| D3 (storage sequence 3) | 3.2 |
| D3 (storage sequence 4) | 9.1 |
| D4 (storage sequence 5) | 3.5 |

### Example 9

### Preparation of a One-Component Adhesive Formulation from Abovementioned Prepolymers

96.5 g of prepolymer from example 2, 1.25 g of 3-glycidyloxypropyltrimethoxysilane (GENIOSIL® GF 80 from Wacker Chemie AG) and 2.25 g of 3-aminopropyltrimethoxysilane (GENIOSIL® GF 96 from Wacker Chemie AG) are stirred together in a suitable mixing apparatus. This gives a yellowish adhesive having a viscosity of 76 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 15.0 |
| D2 (storage sequence 2) | 9.1 |
| D3 (storage sequence 3) | 3.5 |
| D3 (storage sequence 4) | 9.5 |
| D4 (storage sequence 5) | 4.5 |

### Example 10

### Preparation of a One-Component Adhesive Formulation from Abovementioned Prepolymers

96.25 g of prepolymer from example 2, 2.5 g of isooctyltrimethoxysilane (Silan IO-Trimethoxy from Wacker Chemie AG) and 2.25 g of 3-aminopropyltrimethoxysilane (GENIOSIL® GF 96 from Wacker Chemie AG) are stirred together in a suitable mixing apparatus. This gives a yellowish adhesive having a viscosity of 79 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 14.1 |
| D2 (storage sequence 2) | 8.3 |
| D3 (storage sequence 3) | 3.4 |
| D3 (storage sequence 4) | 8.9 |
| D4 (storage sequence 5) | 4.4 |

### Example 11

### Preparation of a One-Component Adhesive Formulation from Abovementioned Prepolymers

98.9 g of prepolymer from example 3 and 1.1 g of 3-aminopropyltrimethoxysilane (GENIOSIL® GF 96 from Wacker Chemie AG) are stirred together in a suitable mixing apparatus. This gives a yellowish adhesive having a viscosity of 80 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 10.4 |
| D2 (storage sequence 2) | 8.6 |
| D3 (storage sequence 3) | 3.1 |
| D3 (storage sequence 4) | 8.5 |
| D4 (storage sequence 5) | 3.2 |

### Example 12

### Preparation of a One-Component Adhesive Formulation from Abovementioned Prepolymers

96.5 g of prepolymer from example 3, 1.25 g of 3-glycidyloxypropyltrimethoxysilane (GENIOSIL® GF 80 from Wacker Chemie AG) and 2.25 g of 3-aminopropyltrimethoxysilane (GENIOSIL® GF 96 from Wacker Chemie AG) are stirred together in a suitable mixing apparatus. This gives a yellowish adhesive having a viscosity of 74 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 15.6 |
| D2 (storage sequence 2) | 9.3 |
| D3 (storage sequence 3) | 3.5 |
| D3 (storage sequence 4) | 9.5 |
| D4 (storage sequence 5) | 4.7 |

### Example 13

### Preparation of a One-Component Adhesive Formulation from Abovementioned Prepolymers

96.25 g of prepolymer from example 3, 2.5 g of isooctyltrimethoxysilane (Silan IO-Trimethoxy from Wacker Chemie AG) and 2.25 g of 3-aminopropyltrimethoxysilane (GENIOSIL® GF 96 from Wacker Chemie AG) are stirred together in a suitable mixing apparatus. This gives a yellowish adhesive having a viscosity of 77 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 14.1 |
| D2 (storage sequence 2) | 8.6 |
| D3 (storage sequence 3) | 3.3 |
| D3 (storage sequence 4) | 8.9 |
| D4 (storage sequence 5) | 4.4 |

### Example 14

### Preparation of a One-Component Adhesive Formulation from Abovementioned Prepolymers

97.5 g of prepolymer from example 4 and 2.5 g of 3-aminopropyltrimethoxysilane (GENIOSIL® GF 96 from Wacker Chemie AG) are stirred together in a suitable mixing apparatus. This gives a yellowish adhesive having a viscosity of 120 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 14.8 |
| D2 (storage sequence 2) | 10.9 |
| D3 (storage sequence 3) | 4.3 |
| D3 (storage sequence 4) | 9.6 |
| D4 (storage sequence 5) | 4.7 |

### Example 15

### Preparation of a One-Component Adhesive Formulation from Abovementioned Prepolymers

58.6 g of prepolymer from example 1, 38.9 g of prepolymer from example 4 and 2.5 g of 3-aminopropyltrimethoxysilane (GENIOSIL® GF 96 from Wacker Chemie AG) are stirred together in a suitable mixing apparatus. This gives a yellowish adhesive having a viscosity of 100 Pas (Brookfield, Spindel 7, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 12.6 |
| D2 (storage sequence 2) | 9.6 |
| D3 (storage sequence 3) | 3.7 |
| D3 (storage sequence 4) | 9.1 |
| D4 (storage sequence 5) | 4.3 |

### Example 16

### Preparation of a One-Component Adhesive Formulation from Abovementioned Prepolymers

69.9 g of prepolymer from example 1, 7.8 g of hexadecyltrimethoxysilane, 20.0 g of ethanol and 2.3 g of 3-aminopropyltrimethoxysilane (GENIOSIL® GF 96 from Wacker Chemie AG) are stirred together in a suitable mixing apparatus. This gives a yellowish adhesive having a viscosity of 0.3 Pas (Brookfield, Spindel 1, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 16.6 |
| D2 (storage sequence 2) | 10.1 |
| D3 (storage sequence 3) | 4.7 |
| D3 (storage sequence 4) | 9.6 |
| D4 (storage sequence 5) | 5.7 |

### Example 17

### Preparation of a One-Component Adhesive Formulation from Abovementioned Prepolymers

83.4 g of prepolymer from example 1, 9.3 g of hexadecyltrimethoxysilane, 5.0 g of ethanol and 2.3 g of 3-aminopropyltrimethoxysilane (GENIOSIL® GF 96 from Wacker Chemie AG) are stirred together in a suitable mixing apparatus. This gives a yellowish adhesive having a viscosity of 10 Pas (Brookfield, Spindel 5, 20 min⁻¹). This adhesive is used to bond beech specimens as described in DIN EN 204, and a determination is made of the tensile shear strengths. In this determination, the values found for this formulation are as follows:

| Durability class | Bond strength N/mm² |
|---|---|
| D1 (storage sequence 1) | 14.2 |
| D2 (storage sequence 2) | 9.8 |
| D3 (storage sequence 3) | 4.2 |
| D3 (storage sequence 4) | 8.9 |
| D4 (storage sequence 5) | 4.9 |

1. A composition (K) comprising
A) 100 parts by weight of a prepolymer (P) comprising in its backbone units (E) selected from polyether units and polyester units, the prepolymer (P) having at least one end group of the general formula (1)
-L¹-(CH₂)_{y}—SiR²₃₋ₓ(OR¹)ₓ (1),
B) 1 to 100 parts by weight of silane (S) of the general formula (2)
R⁴SiR²_{3-z}(OR¹)_{z} (2),
C) 0 to 10 parts by weight of a curing catalyst (HK) which accelerates the curing of the compositions (K) in the presence of atmospheric moisture, where
L¹ is a divalent linking group selected from the group consisting of —O—, —S—, —(R³)N—, —O—CO—N(R³)—, —N(R³)—CO—O—, —N(R³)—CO—NH—, —NH—CO—N(R³)—, and —N(R³)—CO—N(R³),
R¹ and R² are unsubstituted or halogen-substituted hydrocarbon radicals having 1-6 carbon atoms, or hydrocarbon radicals interrupted by nonadjacent oxygen atoms and having a total of 2-20 carbon atoms,
R³ is hydrogen, an unsubstituted or halogen-substituted cyclic, linear or branched C₁ to C₁₈ alkyl or alkenyl radical, a C₆ to C₁₈ aryl radical or a radical of the formula —(CH₂)_{y}—SiR²₃₋ₓ(OR¹)x,
R⁴ is an unsubstituted or halogen-substituted linear, branched or cyclic alkyl, alkenyl or arylalkyl radical having at least 7 carbon atoms,
y is a number from 1 to 10,
x is 2 or 3, and
z is 1, 2 or 3.

2. The composition (K) as claimed in claim 1, wherein the prepolymers (P) have been prepared from polyols (P1) selected from polyether polyols, polyester polyols or mixtures of different polyether and/or polyester polyols, the polyols (P1) or polyol mixtures (P1) having an average molar mass of not more than 2000 daltons.

3. The composition (K) as claimed in claim 1, wherein the prepolymers (P) as well as silane termini of the general formula (1) also possess termini of the general formula (3)
L²-R⁵ (3).
where
R⁵ is an unsubstituted or halogen-substituted linear, branched or cyclic alkyl, alkenyl or arylalkyl radical having at least 7 carbon atoms, and
L² has the same definition as L¹.

4. The composition (K) as claimed in claim 3, wherein 2 to 40% of chain ends of the prepolymers (P) consist of termini of the general formula (3).

5. The composition (K) as claimed in claim 1, wherein R⁴ is a linear or branched alkyl or alkenyl radical having at least 8 carbon atoms.

6. The composition (K) as claimed in claim 1, wherein at least 5 parts of silane (S) are used per 100 parts of prepolymer (P).

7. The composition (K) as claimed in claim 1, wherein the curing catalyst (HK) is selected from the group consisting of titanate esters, tin compounds, basic compounds and acidic compounds.

8. The composition (K) as claimed in claim 1, wherein at least 0.01 part of curing catalyst (HK) is used per 100 parts of prepolymer (P).

9. The composition (K) as claimed in claim 1 further comprising alcohol (A) of the general formula (7)
R⁶OH (7),
where
R⁶ is an unsubstituted or halogen-substituted hydrocarbon radical having 1-20 carbon atoms, or hydrocarbon radical interrupted by nonadjacent oxygen atoms and having a total of 2-20 carbon atoms.

10. A method of using the composition (K) as claimed in claim 1 as adhesive.

11. The composition (K) as claimed in claim 2, wherein the prepolymers (P) as well as silane termini of the general formula (1) also possess termini of the general formula (3)
L²-R⁵ (3),
where
R⁵ is an unsubstituted or halogen-substituted linear, branched or cyclic alkyl, alkenyl or arylalkyl radical having at least 7 carbon atoms, and
L² has the same definition as L¹.

12. The composition (K) as claimed in claim 11, wherein 2 to 40% of chain ends of the prepolymers (P) consist of termini of the general formula (3).

13. The composition (K) as claimed in claim 12, wherein R⁴ is a linear or branched alkyl or alkenyl radical having at least 8 carbon atoms.

14. The composition (K) as claimed in claim 13, wherein at least 5 parts of silane (S) are used per 100 parts of prepolymer (P).

15. The composition (K) as claimed in claim 14, wherein the curing catalyst (HK) is selected from the group consisting of titanate esters, tin compounds, basic compounds and acidic compounds.

16. The composition (K) as claimed in claim 15, wherein at least 0.01 part of curing catalyst (HK) is used per 100 parts of prepolymer (P).

17. The composition (K) as claimed in claim 16 further comprising alcohol (A) of the general formula (7)
R⁶OH (7),
where
R⁶ is an unsubstituted or halogen-substituted hydrocarbon radical having 1-20 carbon atoms, or hydrocarbon radical interrupted by nonadjacent oxygen atoms and having a total of 2-20 carbon atoms.

18. A method of using the composition (K) as claimed in claim 17 as adhesive.
